(19) United States
(12) Patent Application Publication
(10) Pub. No.: US 2026/0249591 A1
(43) Pub. Date: Aug. 27, 2026

(54) COIL COATING PROCESS

(71) Applicant: LAMCOATINGS B.V., Almere (NL)

(72) Inventors: Alessandro BRALIA, Usmate Velate (IT); Antonio D’ORTONA, Almere (NL)

(21) Appl. No.: 18/861,612

(22) PCT Filed: May 19, 2023
(86) PCT No.: PCT/EP2023/063506

§ 371 Date: Oct. 30, 2024

(30) Foreign Application Priority Data
May 19, 2022 (NL) 2031939

(51) Int. Cl. B32B 15/082; B32B 1/00; B32B 7/12; B32B 15/18; B32B 27/08; B32B 27/20; B32B 27/30; B32B 27/36; B32B 37/12; B32B 37/24; B32B 37/26; B32B 38/00; B32B 43/00

(52) U.S. Cl. CPC B32B 15/082; B32B 1/00; B32B 7/12; B32B 15/18; B32B 27/08; B32B 27/20; B32B 27/304; B32B 27/36; B32B 37/1284; B32B 37/24; B32B 37/26; B32B 38/0004; B32B 38/0012; B32B 43/003; B32B 2037/243; B32B 2250/03; B32B 2255/062; B32B 2307/4026; B32B 2307/702; B32B 2307/7376; B32B 2311/30; B32B 2327/06; B32B 2367/00

(57) ABSTRACT

The invention relates to a method for surface coating a plane metal substrate, the method comprising the steps of: providing a coiled plane metal substrate; unwinding the coiled plane metal substrate; applying an adhesive layer onto a top surface of the plane metal substrate; and laminating a layered laminate comprising a PVC film and a PET film onto the top surface of the plane metal substrate, the PVC film contacting the adhesive layer, thereby forming a laminated assembly, wherein the plane metal substrate comprises austenitic stainless steel.

The present invention relates to a method for surface coating a plane metal substrate, to a pre-coated metal substrate obtainable by the method, and to a product comprising the pre-coated metal substrate.

### BACKGROUND ART

Controlled environments like slaughterhouses, dairies, sea food processing, treatment of hides and skins, and salting and brining environments, are all environments where repeated cleaning and decontamination can cause a fast degradation of walls and doors. Sandwich panels are often used to realize walls and partitions in such environments. Sandwich panels are structures made from at least three layers and comprise two facing layers made from a relatively high density material, enclosing a low density insulating core. Traditionally Fiberglass/PET sandwich panels have been the materials of choice, wherein the insulating core comprises the fiberglass. The PET sandwich panel facing layers have to be created through extrusion in the exact shape of the final customer demands. Therefore, the process lacks flexibility, as everything should be produced by an extruder with a customized die. Structurally the product, being a plastic material, cannot be used to realize very high sandwich panels because of the risk that the panel flexes under its own weight. Also for this reason, the thickness of the PET layer is quite high, to guarantee structural robustness. This equally results in a less environmentally friendly product. Finally, coming out from an extrusion process, the surface of such panels can show flow lines and other imperfections due to the die output.

### DESCRIPTION OF THE INVENTION

It is an objective of the present invention to overcome one or more of the abovementioned disadvantages, or at least to provide a useful alternative. Thereto, the present invention provides: a method for surface coating a plane metal substrate, the method comprising the steps of:
providing a coiled plane metal substrate;
unwinding the coiled plane metal substrate;
applying an adhesive layer onto a top surface of the plane metal substrate;
laminating a layered laminate comprising a PVC film and a PET film onto the top surface of the plane metal substrate, the PVC film contacting the adhesive layer, thereby forming a laminated assembly,
wherein the plane metal substrate comprises austenitic stainless steel.

Thus, the laminated assembly comprises at least four layers in the following order: metal, polyester based adhesive, PVC, and PET.

The invention further provides for a laminated assembly obtainable by the method, and a product comprising the laminated assembly. Preferably, the product is a sandwich panel.

Metal layers are more structurally robust and are therefore more suitable for creating sandwich panel facing layers. There is less chance of the panels flexing under their own weight. Coil coating is a continuous and highly automated industrial process for efficiently providing metal with a coating. In a coil coating processes, a metal substrate (usually steel, steel with a metallic coating, stainless steel or aluminium) is delivered in coil form from the rolling mills or galvanizing lines. The weight of the coils varies from 5-6 tonnes for aluminium and up to 20 tonnes for steel. The coil is positioned at the beginning of the coil coating line, and is then unwound at a constant speed, passing through various coating processes before being recoiled. Such process may include cleaning, if necessary, and chemical pre-treatment of the metal surface and either one-side or two-side, single or multiple application of paints or coating powders which are subsequently cured. Laminating with permanent plastic films may be carried out as well. Two strip accumulators which may be found at the beginning and the end of the line enable the work to be continuous, allowing new coils to be added (and finished coils removed) by a metal stitching process without having to slow down or stop the line.

The method according to the invention is preferably performed in a coil coating line. The coil may have a width of maximally 1.8 m, typically about 1.0 to 1.5 m. The plane metal substrate preferably has a thickness of between 0.17 mm to 3.0 mm. At these thicknesses, the metal can suitably be treated by a coil coating process such as the method according to the invention. More preferably, the plane metal substrate, i.e. metal strip, has a thickness of between 0.30 mm and 1.50 mm, as this is the optimal thickness for a coil coating process. Even more preferably, the plane metal substrate has a thickness of between 0.4 and 0.8 mm, as this is the optimum thickness for use in a sandwich panel, providing the best balance between ease of processing, weight of the sandwich panel and strength of the sandwich panel.

After the coil coating process, the laminated assembly may be processed, i.e. cut, in slit coils or plane sheets. There are two types of cutting, referred to as slitting, to produce slit coils: log slitting and rewind slitting. In log slitting the coil is treated as a whole (the ‘log’) and one or more slices are taken from it without an unrolling/re-reeling process. In rewind slitting the web is unwound and run through a machine, passing through knives or lasers, before being rewound on one or more shafts to form narrower rolls. Sheets may be formed by further cutting the rolled metal strip forming the coil or the slit coil in the desired dimensions.

Typically, after coil coating, the metal is cut and then formed to its final shape in cold bending processes. For example, sheets of coated metal may be cut from the coil by cutting the unwound metal in an axial direction. If the metal coil was first slitted into narrower rolls, sheets of the coated metal are often cut from the coil by cutting the metal in sheets in a radial direction.

The plane metal substrate may optionally be pre-treated, for example by degreasing, optionally followed by washing, rinsing, passivation and drying, and/or pre-treatment may comprise chemical pre-treatment based on chrome VI, chrome III or a chrome free passivant. Examples of chrome free passivants are titanium and/or zirconium compounds, particularly complex fluorides of these elements. Additionally or alternatively, a metal substrate primer (i.e. a primer applied on the plane metal substrate, preferably on the top surface of the plane metal substrate) may be used to pre-treat the metal surface before application of the adhesive layer. An anticorrosive primer is however not necessary. Preferably, the method according to the invention does not comprise application of an anticorrosive primer onto the top surface of the plane metal substrate. Thus, the adhesive layer is preferably applied onto the plane metal substrate without application of an anticorrosive primer onto the top surface of the plane metal substrate and the adhesive layer is applied directly to the plane metal substrate.

Because the metal is treated before it is cut and formed, the entire surface is cleaned and treated, providing tightly bonded finishes with reduced effort, cost and use of chemicals. Coil coated metal, or pre-coated metal, is more durable and more corrosion-resistant than post coated metal.

The plane metal substrate used in the invention comprises austenitic stainless steel, and preferably is made from austenitic stainless steel. Stainless steels are steel alloys with at least 11 percent (maximum 30%) chromium, which prevents corrosion of iron particles and enhances their ability to withstand higher temperatures. Austenitic stainless steel is especially corrosion resistant and can be used all the way from a cryogenic to a high temperature range due to the ductility, toughness and mechanical strength that is sustained over a wide temperature range. The primary crystalline structure is austenite (face-centered cubic) and the steel is essentially non-magnetic, which makes austenitic stainless steel especially suitable in the construction of buildings where magnetic fields are likely to be produced.

PVC may be flexible or rigid. Flexible PVC typically comprises a plasticizer, whereas rigid PVC does not contain a plasticizer, or only contains a small amount of plasticizer (e.g. less than 100 ppm, preferably less than 10 ppm, most preferably less than 1 ppm). Plasticizers or dispersants are additives that increase the plasticity or decrease the viscosity of a material. These are the substances, which are added in order to alter the physical properties of a material, and they are either liquids with low volatility or solids. They decrease the attraction between polymer chains to make them more flexible. Over the last 60 years, more than 30,000 different substances have been evaluated for their plasticizing properties. Of these, only a small number-approximately 50-are in commercial use today. Most commonly phthalate esters are used as plasticizers in PVC. Plasticizers are typically low molecular weight compounds, although polymeric plasticizers exist as well. Nevertheless, plasticizers typically have a molecular weight lower than 5000 g/mol. Over time, low molecular weight plasticizers may migrate through the layers and evaporate. This results in porosity, brittleness and shrinking of the film. In turn, this leads to decreased aesthetics and to corrosion of the underlying metal. Particularly preferably, the PVC of the invention contains less than 100 ppm, preferably less than 10 ppm, most preferably less than 1 ppm plasticizers with a molecular weight lower than 5000 g/mol. Furthermore, rigid PVC has a lower permeability to water vapour because no plasticizers are present in the rigid PVC.

Preferably, the PVC used in the invention is rigid PVC. Rigid PVC may contain impact modifiers. Impact modifiers are added to plastic materials to improve their durability and toughness. Impact modifiers are generally polymeric compounds. Examples are MBS (methyl butadiene styrene) polymers and polyacrylics.

Furthermore, PVC is very resistant to acids and bases. PVC is also inherently fire resistant. PVC may further comprise pigments. Preferably, the PVC film comprises one or more pigments. Suitable pigments are for example metal oxides, such as titanium dioxide, or organic pigments. Common types of organic pigments can include azo pigments, lake pigments, phthalocyanine pigments and quinacridone pigments. A disadvantage of PVC is its lower solvent resistance. Also, PVC may suffer from alteration of gloss, such as reduced gloss, after it has been processed at high temperatures, such as the high processing temperatures used during coil coating, which are typically between 130-250° C., such as between 200-250° C.

Preferably, the PVC film has a thickness of between 70 and 200 μm, more preferably of between 100 and 160 μm, most preferably of between 110 and 135 μm.

Solvent resistance and gloss are provided by the PET (polyethylene terephthalate) film. Due to the PET top layer, the coated metal substrate is easy to clean, food safe, and has appealing aesthetics.

Preferably, the PET film has a total thickness of between 6 and 50 μm, more preferably of between 9 and 32 μm, most preferably of between 12 and 20 μm.

Polymeric films with a thickness of less than 300 μm have a very low, but inherent risk of comprising through-holes. Due to the presence of two polymeric films on the metal substrate, the danger of holes in a single film leading to attack of the metal substrate through such a hole by water or chemicals is largely avoided. The chances of a hole in the PVC layer and a hole in the PET layer overlapping, leading to a path from the outer surface to the metal is close to 0%.

Preferably, the layered laminate comprises amorphous PET coextruded with semicrystalline PET, more preferably the amorphous PET has been thermally fused with a rigid PVC film. The lattter may have been accomplished by simultaneously coextruding the two PET layers and the PVC, or by first coextruding both PET layers, and then applying a PVC layer. The layered laminated is most preferably produced by bonding together 1 multilayer PET (amorphous and semicrystalline) film and 1 layer of rigid PVC.

The semicrystalline PET layer which covers the amorphous PET layer is more solvent resistant than amorphous PET, whereas the adhesion between the amorphous PET layer (which is in between the semicrystalline PET and PVC layers) and PVC is stronger. In this case, preferably, the amorphous PET has a thickness of between 0.1 and 3 μm, more preferably of between 0.2 and 2 μm, most preferably of between 0.4 and 0.6 μm. The crystalline PET preferably has a thickness of between 5.9 and 47 μm, more preferably of between 8.8 and 30 μm, most preferably of between 11.6 and 19.4 μm.

Preferably, the adhesive layer comprises a polyester based adhesive, as a polyester based adhesive has proven to result in the strongest adhesion between the PVC film and the austenitic stainless steel, thereby providing the best protection against delamination. The polyester based adhesive layer may be applied by reverse roller coat or spray coating. The layer is preferably applied by reverse roller coat. The adhesive layer preferably has a thickness of about 5-25 μm, more preferably of about 5-15 μm, most preferably of about 5-10 μm.

Finally, the laminated assembly may further comprise a strippable film. The strippable film covers the PET layer and may be applied as a final step in the coil coating process, i.e. the method of the invention, before the unwound and laminated coil is rewound, in order to protect the laminated surface of the coated coil during shipment and handling. Thus, in a preferred embodiment, the method according to the invention further comprises applying a strippable film covering the PET top layer.

The method of the invention may further comprise applying a backing coating to a bottom surface of the coiled plane metal substrate. Different types of back coats can be applied depending on the customer demand and the kind of metal substrate. An epoxy primer is a common choice. The backing coating may for example be applied at the same time as the adhesive.

Preferably, the method according to the invention further comprises rewinding the laminated assembly resulting in a laminate coil. The method according to the invention may further comprise cutting the laminated assembly to produce slit coils.

The pre-coated metal coil or slit coil of the invention may be cut into pre-coated metal sheets. These metal sheets may be formed into their final shape by cold bending and applied in a product, such as a sandwich panel. Thus, preferably, the method according to the invention further comprises cutting the laminated assembly to produce pre-coated metal sheets.

### Example 1

A 0.6 mm thick coil of austenitic stainless steel was unwound, degreased and pre-treated by a passivant liquid. The polyester based adhesive was applied in a film thickness of 8 μm by using a reverse roll coating process at a line speed of 20 m/min, curing it up to 232° C. for a total of 30 sec. Then the film was laminated with a layered laminate of 120 μm rigid PVC, 0.5 μm amorphous PET and 19.5 μm semicrystalline PET immediately outside the oven. Then the coil was cooled down by water and dried up. A protective film was applied in line and the coil was rewound. The laminated assembly was cut into sheets, and formed into an outer layer for a sandwich panel in a cold bending process. The outer layer for a sandwich panel complies with EN 13523.

1-14. (canceled)

15. Method for surface coating a plane metal substrate, the method comprising the steps of:
providing a coiled plane metal substrate;
unwinding the coiled plane metal substrate;
applying an adhesive layer onto a top surface of the plane metal substrate; and
laminating a layered laminate comprising a PVC film and a PET film onto the top surface of the plane metal substrate, the PVC film contacting the adhesive layer, thereby forming a laminated assembly,
wherein the plane metal substrate comprises austenitic stainless steel, wherein the layered laminate comprises amorphous PET coextruded with semicrystalline PET, optionally wherein the amorphous PET has been thermally fused with a rigid PVC film.

16. The method according to claim 15, wherein the PET film has a total thickness of between 6 and 50 μm.

17. The method according to claim 15, wherein the adhesive layer comprises a polyester based adhesive.

18. The method according to claim 1, wherein the PVC film comprises one or more pigments.

19. The method according to claim 1, wherein the adhesive layer is applied onto the plane metal substrate without application of an anticorrosive primer onto the top surface of the plane metal substrate.

20. The method of claim 19, wherein the adhesive layer comprises a polyester based adhesive.

21. The method according to claim 1, further comprising applying a strippable film covering the PET top layer.

22. The method according to claim 1, further comprising applying a backing coating to a bottom surface of the plane metal substrate.

23. The method according to claim 1, further comprising rewinding the laminated assembly resulting in a laminate coil.

24. The method according to claim 1, further comprising cutting the laminated assembly to produce slit coils.

25. The method according to claim 1, further comprising cutting the laminated assembly to produce pre-coated metal sheets.

26. A laminated assembly obtainable by the method of claim 1.

27. A product comprising a laminated assembly according to claim 25.

28. The product according to claim 26, wherein the product is a sandwich panel.
